(19) United States
(12) Patent Application Publication
(10) Pub. No.: US 2004/0023774 A1
(43) Pub. Date: Feb. 5, 2004

(54) Apparatus for forming folds in material

(75) Inventors: Timothy J. Blenke, Neenah, WI (US); Dennis E. Harris, Neenah, WI (US)

Correspondence Address: SENNIGER POWERS LEAVITT AND ROEDEL, ONE METROPOLITAN SQUARE, 16TH FLOOR, ST LOUIS, MO, 63102, US

(73) Assignee: Kimberly-Clark Worldwide, Inc.

(21) Appl. No.: 10/208,131

(22) Filed: Jul. 30, 2002

(51) Int. Cl. B31F 7/00

(52) U.S. Cl. 493/356

(57) ABSTRACT

Apparatus forms folds in a continuously moving web by passing the web over skis. The folds may be arranged to form pleats. The skis are individually movable to facilitate adjustment. Adjustment of the skis can be done while the web is moving through the apparatus. Further, the portions of the web immediately to the sides of the skis are controlled by respective material guides to make certain the pleat folds are properly formed on the sides of the pleated section. The web is continuously and automatically guided to maintain a substantially constant position in a direction transverse to the web.

### BACKGROUND OF THE INVENTION

This invention relates generally to machines for processing drapable or foldable materials, and more particularly to apparatus for forming folds in such material.

Folding material such as to form pleats in material has many applications such as for draperies and garments. In the field of garments, pleats are used for aesthetic appeal as well as for functional purposes. In particular, pleats allow the dimension of the garment to be changed without stretching the material so that a garment may be fit adaptive even though it employs materials which are not elastic or resilient. Unfolding of the pleats increases the dimension of the material in a direction transverse to the lengthwise extension of the pleat folds. Resiliency which urges the pleats toward their folded position may be achieved by attaching a resilient material to the pleated material. However, even the capability of stretchable material to extend can be enhanced by the provision of pleats. Pleats have other useful functional purposes, such as creating channels or barriers in an absorbent article to guide fluids.

The manufacturer of an article having pleats requires that such pleats be formed in a rapid and continuous manner so as to fit in to an automated or substantially automated process. Although the entire width of material may be formed with pleats, often only a smaller area is so formed. It is known to make pleats in an assembly line process by running a web of material through an array of elongate stainless steel skis which are arranged parallel to the path of the material to be pleated. To achieve this, skis are positioned in generally opposite, but laterally offset arrangement and interleaved so that material passing along the length of the skis must be folded back and forth in a small area so that the material assumes a generally sinusoidal shape when viewed in cross section. The edges of the skis form folds in the material in closely spaced relation. The folds may more permanently be formed into pleats by passing through a press after leaving the array of skis.

It has been found that somewhat frequent adjustment of pleating apparatus of the type just described is necessary to properly form pleats. Certainly, different kinds of material will require a different adjustment of the skis. For instance, material which is more difficult to fold may require some angulation of the skis away from parallel so that a heel of the ski juts into the material somewhat. The angulation of the ski will depend upon the type of material. Some materials (e.g., a tissue paper) may tear if the heel juts too far out. It has been found that the properties of even the same material may vary slightly from roll to roll of the material so that some small adjustment may be required. Usually, the adjustments require some element of trial and error to achieve the best result. In existing pleating equipment, it is difficult to make these adjustments rapidly and not practical to do so while the pleating apparatus is in operation. Shutting down the entire assembly line to make these adjustments is highly undesirable. In addition if a different size of pleat is to be formed, the necessary adjustments and changes can be time consuming.

Conventional continuous pleating apparatus occupies a horizontal space of perhaps 5 to 8 feet in a production line. This occupation of space makes demands on valuable factory floorspace, and can indirectly place constraints on the size of other components. Still another problem associated with current pleating apparatus is maintaining a fold at the laterally outer skis of the array of skis. The material tends to straighten out rather than form a fold against the edge of the outer ski so that an adequate fold and hence no pleat may be formed around the outer ski.

### SUMMARY OF THE INVENTION

Fold forming apparatus of the present invention permits rapid and flexible adjustment. Moreover, at least some adjustments can be made while the apparatus is in operation. The skis can be individually adjusted while the apparatus is in operation, i.e., while a web of material runs through the apparatus. The apparatus also maintains a fold at the laterally outer edges of the two skis which are located on opposite sides of the set or sets of skis used to form the pleats. Still further, alignment of the web through the pleating apparatus is precisely controlled.

In one aspect of the present invention, apparatus for forming folds in a foldable material in a continuous operation generally comprises a frame adapted for receiving a moving web of the foldable material through the apparatus along a path. A plurality of skis mounted on the frame are adapted to engage the web of foldable material for use in forming folds in the engaged web as the web of foldable material moves through the apparatus along the path. The skis are mounted for independent adjustment within the apparatus.

Generally, in another aspect of the present invention, apparatus for forming folds in a foldable material in a continuous operation comprises a frame adapted for receiving a moving web of the foldable material through the apparatus along a path. A plurality of skis mounted on the frame are adapted to engage the web of foldable material for use in forming folds in the engaged web as the web of foldable material moves through the apparatus along the path. A material guide for engaging the web of foldable material forms the material in cooperation with at least one of the skis to produce at least one of the folds.

In still another aspect of the invention, apparatus for forming folds in a foldable material in a continuous operation comprises a frame adapted for receiving a moving web of the foldable material through the apparatus along a path. A plurality of skis mounted on the frame are adapted to engage the web of foldable material for use in forming folds in the engaged web as the web of foldable material moves through the apparatus along the path. A web straightener mounted on the frame upstream along the path of the web from the skis automatically corrects the position of the web laterally of its path.

Other aspects and features of this invention will be in part apparent and in part pointed out hereinafter.

### BRIEF DESCRIPTION OF THE DRAWINGS

FIG. 1 is a front elevation of a pleating apparatus of the present invention showing a fragmentary segment of a web of foldable material extending therethrough;

FIG. 2 is a side elevation of the pleating apparatus showing different fragments of the material web;

FIG. 3 is an enlarged section of the apparatus showing pleating skis of the apparatus in an interleaved position;

FIG. 4 is a section taken in the plane including line 4-4 of FIG. 3 and showing the web as formed by the skis;

FIG. 4A is an elevation partially in section taken from the vantage indicated by line 4A-4A in FIG. 4;

FIG. 5 is an enlarged top plan view of a ski; and

FIG. 6 is an enlarged side elevation of a ski, a tilted position of the ski being shown in phantom;

FIG. 7 is a cross section of the web after passing over the pleating skis but prior to entering a press of the apparatus; and

FIG. 8 is a cross section of the web after passing through the press.

Corresponding reference characters indicate corresponding parts throughout the several views of the drawings.

Definitions

Within the context of this specification, each term or phrase below will include the following meaning or meanings:

(a) “Bonded” refers to the joining, adhering, connecting, attaching, or the like, of two elements. Two elements will be considered to be bonded together when they are bonded directly to one another or indirectly to one another, such as when each is directly bonded to intermediate elements.

(b) “Layer” when used in the singular can have the dual meaning of a single element or a plurality of elements.

(c) “Meltblown” refers to fibers formed by extruding a molten thermoplastic material through a plurality of fine, usually circular, die capillaries as molten threads or filaments into converging high velocity heated gas (e.g., air) streams which attenuate the filaments of molten thermoplastic material to reduce their diameters. Thereafter, the meltblown fibers are carried by the high velocity gas stream and are deposited on a collecting surface to form a web of randomly dispersed meltblown fibers. Such a process is disclosed, for example, in U.S. Pat. No. 3,849,241 to Butin et al. Meltblown fibers are microfibers which may be continuous or discontinuous, are generally smaller than about 0.6 denier, and are generally self bonding when deposited onto a collecting surface. Meltblown fibers used in the present invention are preferably substantially continuous in length.

(d) “Non-woven” and “non-woven web” refer to materials and webs of material which are formed without the aid of a textile weaving or knitting process.

(e) “Pliable” refers to materials which are compliant and which will readily conform to the general shape and contours of the wearer's body.

### DETAILED DESCRIPTION OF THE DRAWINGS

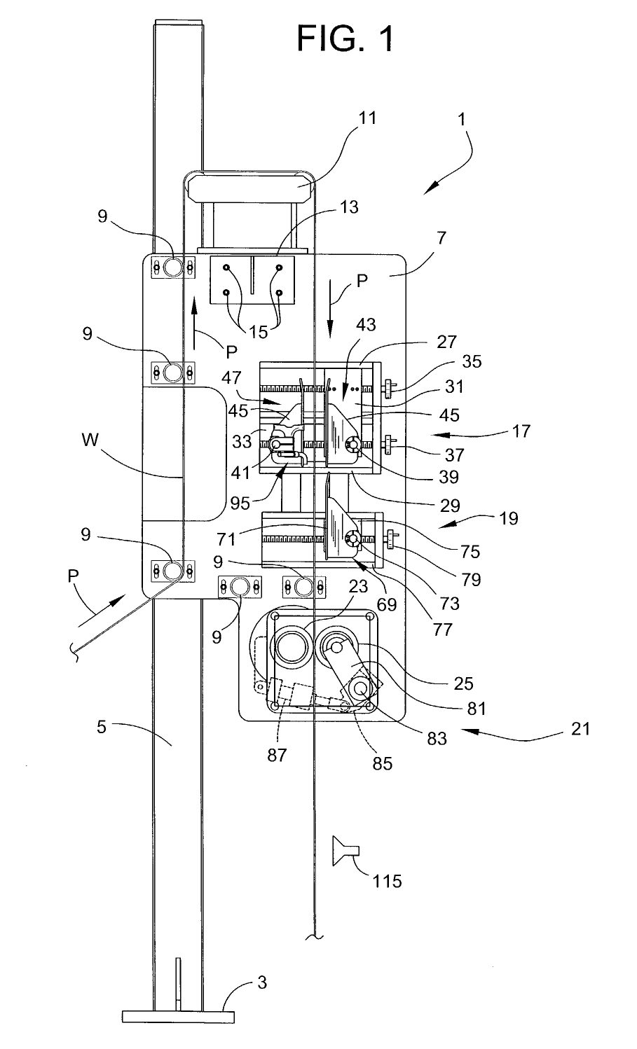

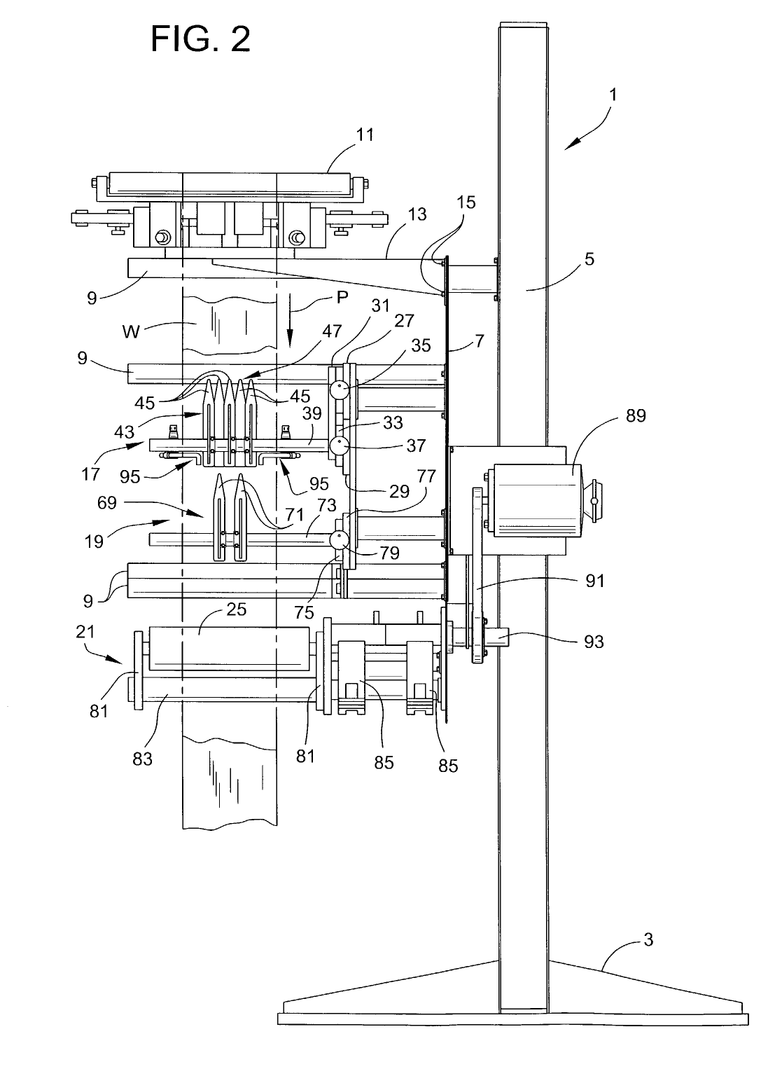

Referring now to the drawings and in particular to FIGS. 1 and 2 a pleating apparatus (broadly, “apparatus for forming folds”) constructed according to the principles of the present invention is indicated generally at 1. The pleating apparatus includes a frame having a stand 3 and an upright 5 projecting upwardly from the stand. The stand 3 can be mounted as by bolts (not shown) on the floor or not attached to the floor, as needed. A faceplate 7 attached to the upright 5 mounts several components to be described for handling a web W of foldable material which passes through the apparatus 1 along a path and in a direction indicated by the arrows P in the drawings. If the pleating apparatus 1 is part of an assembly line (not shown) the web is fed from an upstream station, through the pleating apparatus and to a downstream station. In one embodiment, the pleating apparatus 1 is particularly adapted for use in an assembly line for forming disposable absorbent articles (not shown) such as diapers, training pants, incontinence products and feminine care products. For example, in a diaper a substantially inextensible tissue bodyside liner could be formed with pleats to allow the liner to extend. By attaching the pleated tissue to an outer cover of elastic material, the tissue can also acquire some resilient properties. Pleats may be used on garments generally in a conventional fashion which allows the garment to have a fitted style while retaining comfort because the pleats permit the garment material to expand. However, it is to be understood that the apparatus 1 of the present invention may be used for forming pleats in articles other than disposable absorbent articles, including articles other than garments. Pleats could also be used to reduce the cross machine dimension of a sheet of material, allowing it to be collected on a shorter roll. The material could be stretched out again after it was fed from the roll. Pleats are well known for use in articles of many types, including air filters to increase the surface area of the filter.

In the context of manufacturing a disposable absorbent article, the web W of foldable material might be non-woven materials such as: spunbond; flexible, light weight SMS (spunbond—melt blown—spunbond) composite; creped and uncreped tissue; newsprint; flexible polymer film; scrim (tissue or non-woven laminate with scrim laminated between outer materials; and any other light weight, flexible materials. However, the apparatus 1 may operate on still other materials, including multiple layers of material without departing from the scope of the present invention.

The web W of material entering the pleating apparatus 1 is turned from a somewhat horizontal direction to a vertical direction by guide rollers 9 mounted at vertically spaced apart locations on the faceplate 7 adjacent an upstream side thereof. The terms “upstream” and “downstream” as used herein refer to both a position with reference to the direction of movement of the web W of material, and also a position with respect to the flow of the web through the assembly line. In the illustrated embodiment, the guide rollers 9 can engage the web W to change or maintain its direction while allowing the web to move past the rollers with minimal drag. However, it is envisioned that other forms of guiding devices and structures (not shown) may be used. The web W passes over the top of a web straightener 11 mounted on a shelf 13 mounted as by bolts 15 to the faceplate 7 in cantilever fashion. The web straightener 11 is operable to detect the lateral position of the web W as it passes over the web straightener and to automatically adjust the lateral position to maintain the web substantially centered on a centerline of the path through the apparatus 1. A suitable web straightener is commercially available, such as a Symed 50 straightener system from Fife Corporation of Oklahoma City, Okla.

The web W is guided downwardly from the web straightener 11 to a forming section (indicated generally at 17) where the web of material undergoes the initial formation to create pleats PL in the web. FIGS. 1 and 2 show the pleat forming section 17 in an open configuration in which pleats PL are not being formed in the material web W so that the individual components of the pleating apparatus 1 can be more clearly seen. Just below the forming section 17 is a retainer, indicated generally at 19, for use in retaining the shape of the web W formed in the forming section. The formed web W then passes downwardly past another of the guide rollers 9 to a press, generally indicated at 21, which presses the web in a nip between a fixed roller 23 and a pivoting roller 25 to set the pleats PL formed in the forming section 17 into the material of the web. The web W then exits the pleating apparatus 1 to other processing machinery, or to a collection device if no further operations are to be performed on the material immediately after leaving the apparatus. The arrangement of components of the pleating apparatus 1 which allows the web W to extend vertically through much of the apparatus causes the apparatus to occupy very little space on a factory floor. In the illustrated embodiment, the apparatus 1 can achieve a process length of the web W through the apparatus of about 21 inches.

The forming section 17 includes an upper track 27 and a lower track 29 which are mounted on the faceplate 7. A first slide 31 is attached to the upper track 27 for sliding movement horizontally of the apparatus 1 and perpendicular to the web W, and a second slide 33 is attached to the lower track 29 for sliding movement horizontally of the apparatus 1 and perpendicular to the web in the same manner as the first slide. A first lead screw having a knob 35 is threadably connected to the first slide 31 such that rotation of the knob causes sliding movement of the first slide along the upper track 27. Similarly, a second lead screw having a knob 37 is threadably connected to the second slide 33 such that rotation of the knob causes sliding movement of the second slide along the lower track 29. The first and second slides 31, 33 have mounting bars (designated 39 and 41, respectively) projecting outwardly from the slides and movable conjointly with the slides toward or away from each other, depending upon the direction in which the knobs 35, 37 are rotated. The mounting bar 39 mounts a set 43 of skis 45 and the mounting bar 41 mounts a set 47 of the skis 45, as will be described.

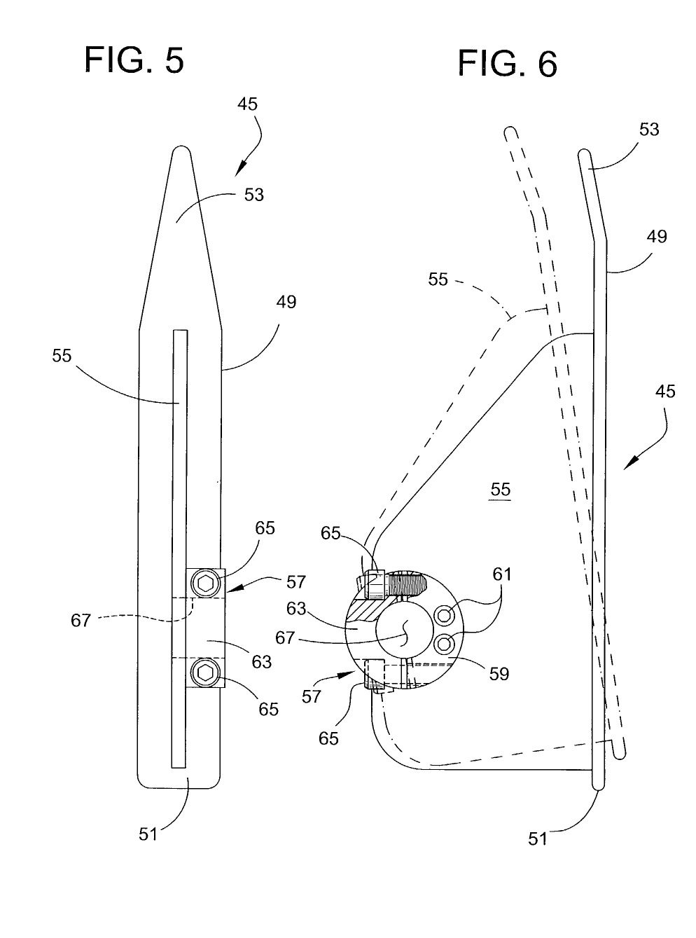

Referring to FIGS. 5 and 6, each ski 45 comprises a runner 49 having a heel 51 and a turned out toe 53 which tapers in width (see FIG. 5) toward its free end opposite the heel. The runner 49 is fixedly attached to a thin, flat mounting plate 55 which extends perpendicularly outwardly from the runner 49. A clamp collar generally indicated at 57 includes a first semi-circular element 59 fixedly attached as by screws 61 to the mounting plate 55 and a second semi-circular element 63 releasably attached to the first element by bolts 65. Each ski 45 can be mounted on one of the mounting bars 39 or 41 by loosening the bolts 65 to separate the first and second semi-circular elements 59, 61. The ski 45 is slid onto the bar 39 or 41 with the bar being received in an opening 67 defined by the first and second elements and extending through the mounting plate 55. Tightening the bolts 65 secures the ski 45 on the mounting bar 39 or 41. As illustrated in phantom in FIG. 6, the ski 45 can be attached in different angular orientations on the mounting bar 39 or 41 (not shown in FIG. 6) by holding the ski in a selected position and tightening the bolts 65 to temporarily, but securely fix the position. It will readily be understood that the adjustment of each ski 45 in this manner is independent of any other ski on either mounting bar 39, 41.

The retainer 19 (FIG. 1) is, in the illustrated embodiment, another set 69 of skis 71 attached by a mounting bar 73 to a slide 75 received for horizontal sliding motion on a track 77. The track is attached to the faceplate 7 at a position downstream from the two sets of skis 43, 47 in the forming section 17 and before the press 21. The retainer skis 71 may be of substantially the same construction as the skis 45 associated with the forming section 17. The skis 71 are mounted on the mounting bar 73 in the same way as the skis 45 described above, and are capable of the same adjustments. A lead screw having a knob 79 is capable of actuating sliding motion of the slide 75 along the track 77 by turning the knob to position the retainer skis 71. It is to be understood that the retainer skis 71 may be entirely omitted without departing from the scope of the present invention. Generally speaking, the retainer skis 71 are more useful with some kinds of materials, which tend to spring back to a flat shape after forming, than with others that hold the shape given to them in the forming section 17. A few examples of materials which tend not to hold a pleat are heavy basis weight nonwoven materials (e.g., SMS), stretch laminations and heavy polymer films.

The pivoting roller 25 of the press 21 is mounted by arms 81 attached to a pivot rod 83 pivotally mounted on the faceplate 7. Lever plates 85 attached to the pivot rod 83 are pivotally connected to respective pneumatic cylinders 87. It is to be understood that hydraulic or other types of cylinders, or drivers other than cylinders may be used without departing from the scope of the present invention. Extension and retraction of the pneumatic cylinders 87 positions the pivoting roller 25 and selects the force applied to the web W in the nip between the fixed roller 23 and the pivoting roller. The fixed roller 23 is driven in rotation by a motor 89 mounted on the upright 5 behind the faceplate 7. The motor 89 is connected by a belt 91 to a shaft 93 which drives rotation of the fixed roller 23 to pull the web W pinched between the fixed roller and the pivoting roller 25 through the apparatus 1.

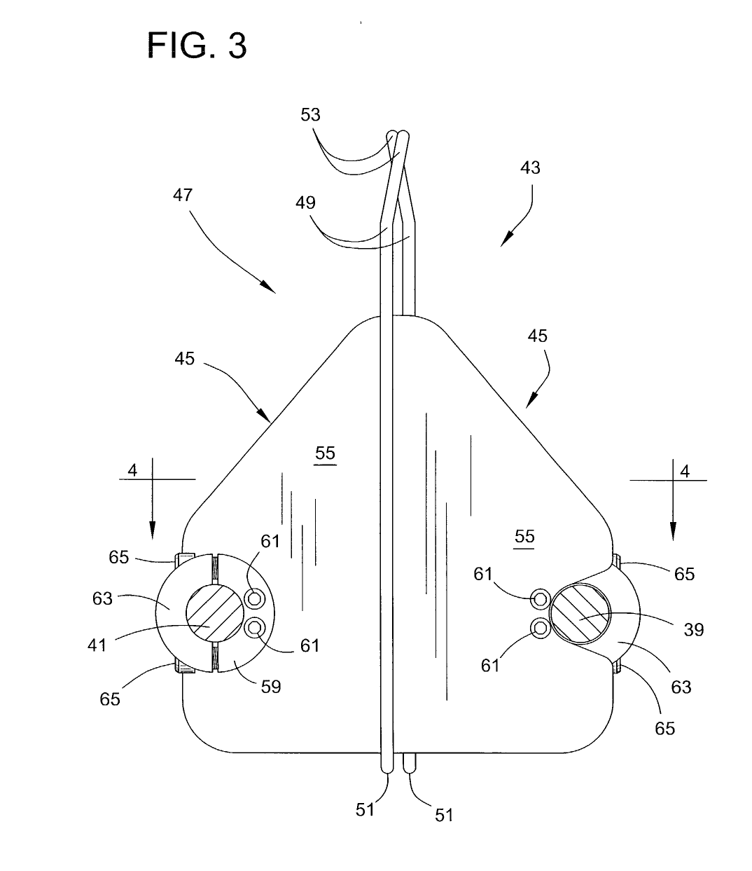

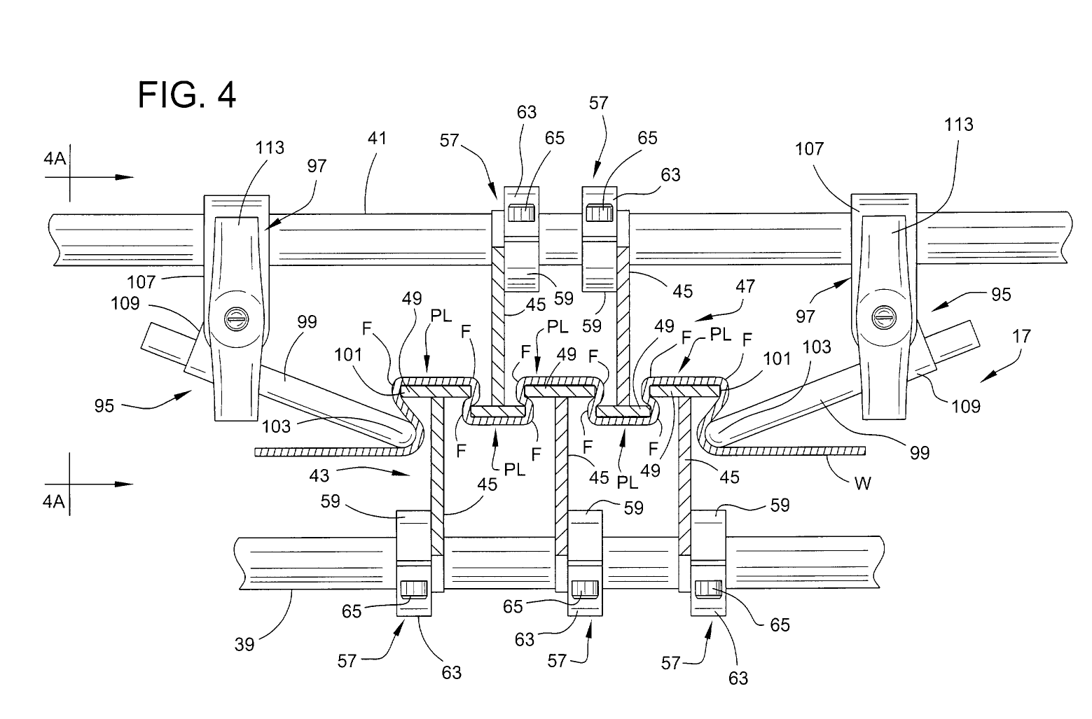

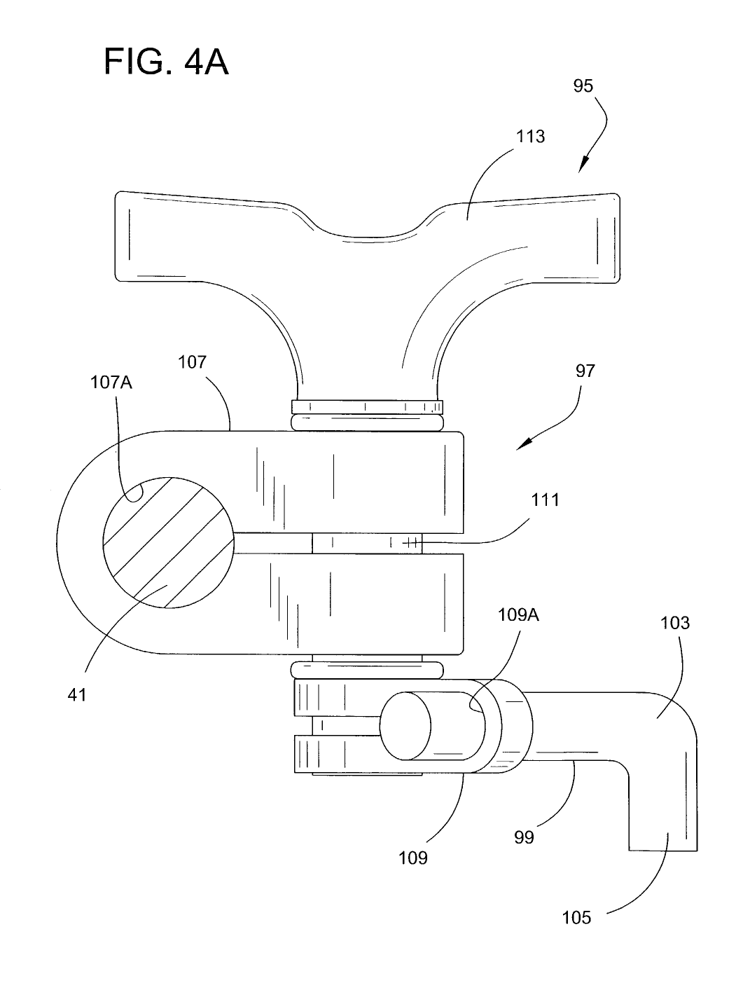

Referring now to FIGS. 3 and 4, the skis 45 of the pleating section 17 are interleaved in operation of the pleating apparatus 1. The skis 45 may be moved from the position shown in FIG. 1 to that shown in FIGS. 3 and 4 by turning the knobs 35, 37 to slide the mounting bars 39, 41 and associated set 47 of skis toward each other until the runners 49 of each set of skis pass the runners of the other set of skis. The skis 45 of the opposed sets 43, 47 are offset to permit interleaving to occur. FIG. 3 illustrates the interleaved ski sets 43, 47 with the distal portions of the mounting bars 39, 41 broken away so that the outer two skis 45 in each set are seen without obstruction. It may be seen that the runner 49 of the ski 45 associated with the set 47 of skis is located to the right of the runner 49 of the ski associated with the set 43 of skis. This arrangement of the ski sets 43, 47, when the material is received through the forming section 17 as shown in FIG. 4, causes the material of the web W to be formed in a roughly sinusoidal configuration, bending back and forth from a ski 45 of one set (43 or 47) to an adjacent ski of another set (47 or 43). Folds F may be formed by the longitudinal edges of the skis 45 which engage the web W so that after passing through the press 21, pleats PL are formed. It is envisioned that for certain applications, the press 21 would not be necessary to produce the pleats PL.

FIGS. 4 and 4A also particularly illustrate material guides 95 mounted on the mounting bar 41 by clamps 97 on opposite sides of the sets 43, 47 of skis 45 (the reference numerals 95 and 97 designating the subjects generally). The material guides 95 comprise in the illustrated embodiment generally L-shaped rods 99 held by the clamps 97 so that they project into engagement with the web W forming the material around the outer longitudinal edges 101 of the runners 49 of the skis 45 of the set 43 which are on the sides of the interleaved ski sets. In this way, a fold F can be formed in the material of the web W by the outside longitudinal edges 101 of the runners 49 of these outside skis 45 of the set 43. Otherwise, the web W tends to flatten out which prevents a pleat from forming on the outer skis. The rods 99 each include a curved portion 103 which first engages the web W as it travels along its path. The web W then slides along a shorter section 105 of the L-shaped rod 99.

Each clamp 97 includes a first, flattened-U shaped section 107 which is releasably attached to the mounting bar 41 and a second, flattened-U shaped section 109 which is attached to the first section and holds the L-shaped rod 99. A bolt 111 having a T-shaped handle 113 is threadably received through aligned pairs of openings in both the first and second sections 107, 109. The openings are located generally toward opposed free ends of the U-shaped first and second sections. Near the bottom of each “U” formed by the first and second sections 107, 109 is a generally circular hole (designated 107A and 109A, respectively) sized and shaped in the first section 107 to receive the mounting bar 41 and sized and shaped in the second section 109 to receive the L-shaped rod 99. If the handle 113 is turned to allow the first and second sections 107, 109 to open, the circular holes 107A, 109A are large enough to permit the material guide 95 to slide along and pivot on the mounting bar 41. At the same time, the L-shaped rod 99 can be adjusted axially of the mounting bar 41 by sliding in the hole 109A. The second section 109 can also be rotated relative to the first section 107 about the longitudinal axis of the bolt 111 to change the angular position of the L-shaped rod 99. Once the material guide 95 is positioned along the mounting bar 41 and the L-shaped rod 99 arranged in a selected angular and axial position, the handle 113 can be turned to squeeze both the first and second sections 107, 109 to reduce the diameters of the circular holes 107A, 109A. The first section 107 is secured on the mounting bar 41, and the L-shaped rod 99 is fixed axially in the second section 109 and in a particular angular position. It will be readily appreciated that the material guide 95 is capable of quick and easy adjustment.

Having described the construction of the pleating apparatus 1, its operation will now be described. Initially, the web W of material from a location upstream of the pleating apparatus is threaded through the pleating apparatus. The upstream location could be occupied by, for example, a roll of material or another piece of material processing equipment (not shown). Threading the web W of material involves guiding it past the guide rollers 9 and over the web straightener 11. The web W then is fed through the forming section 17, through the retainer 19 (if required) and another guide roller 9 into and through the nip of the press 21. The force applied by the pivoting roller 25 is selected and the appropriate adjustment to the pneumatic cylinders 87 is made. The web W then is passed out of the pleating apparatus 1 to a collection device or to another piece of processing equipment.

Either before or after threading the web W through the apparatus 1, pleating skis 45 are selected and mounted on respective mounting bars 39, 41 in the two opposed sets 43, 47. The skis 45 may be selected from a number of pre-fabricated skis, the primary difference between the skis being the width of the runners 49, although the skis could be otherwise different without departing from the scope of the present invention. The width of the runner 49 is selected to achieve a particular width of pleat PL in the formed material web. The skis 45 selected may have runners 49 with the same width or different widths. The number of skis 45 will depend upon the transverse dimension of the web W which is to be pleated and the width of the pleats PL to be formed. The skis 45 are each mounted on respective mounting bars 39, 41 by loosening the bolts 65 connecting the semi-circular elements 59, 63 of the clamping collar 57 so that the collar can be slidingly received on the mounting bar 39 or 41, allowing the ski to be positioned anywhere along the length of the mounting bar.

Once in position, the angle of the ski 45 can be selected by manually turning the ski about the axis of the mounting bar 39 or 41. The angle of the ski 45 is selected depending upon the type of material being pleated, and/or upon the shape (i.e., depth) of the pleat desired. Generally, the heel 51 of the ski 45 is angled inward, toward the opposite mounting bar 39 or 41, to make a more aggressive fold and/or to deepen the pleat. Alternatively, the ski could be adjusted such that the heel 51 is angled outward, away from the opposite mounting bar 39 or 41, so that the turned out toe 53 engages the web W to make a less aggressive fold and a shallower pleat. Once both the position of the ski 45 along the mounting bar 39 or 41 and its angular position are established, the bolts 65 are tightened to fix the position of the ski. The same operation can be repeated for other skis 45 attached to the mounting bars 39, 41, with some space being left between adjacent skis on each mounting bar. It will be understood that the skis 45 on the same mounting bar 39 or 41 may be and often are angled at different angles in order to produce finished pleats PL which are uniform in size and shape.

Before the first ski 45 of the set of skis 47 is put onto the mounting bar 41 (as viewed in FIG. 4), a material guide 95 is placed on the mounting bar at a location which is inward (i.e., toward the faceplate 7) of the location where the skis will be mounted. After the skis 45 of the set 47 are mounted on the mounting bar 41, a second material guide 95 is placed on the bar at a location outward of the skis (i.e., farthest from the faceplate 7). In the illustrated embodiment, three skis 45 for the set 43 are placed on the mounting bar 39 and two skis form the set 47 on the mounting bar 41, although the sets could include other numbers of skis (including zero). It will be understood that an entire set of skis (e.g., set 47) could be omitted from the pleating apparatus resulting in a single pleat that has a width equal to the length across an entire set of skis. When only one set of skis (e.g., set 43) are used, the material guides 95 fold the web W around the outer longitudinal edges 101 of the inner and outer skis 45 to form the single pleat. Another way to select the width of one or more pleats is to omit an interleaving ski 45 at one or more locations so that the width of the pleat is essentially equal to the width of two adjacent skis in the same set plus their spacing.

The skis 45 in the set 47 on the mounting bar 41 are laterally offset from the skis in the set on 43 the mounting bar 39 so that they can be interleaved. Interleaving is accomplished by turning one or both of the knobs 35, 37 to move the first and second slides 31, 33, and hence the mounting bars 39, 41 toward one another so that the runners 49 of the skis 45 in each set pass the runners of the other set to the position shown in FIGS. 3 and 4. The depth of the pleat PL formed can also be controlled by the distance the runners 49 of opposed sets 43, 47 pass each other. The web W of material assumes the generally sinusoidal shape shown in FIG. 4 when engaged by the interleaved skis. It may be seen that the material guides 95 fold the web W around the outer longitudinal edges 101 of the inner and outer skis of the set. The material guides 95 are readily adjusted after the skis 45 are interleaved to achieve the proper fold F along the outer longitudinal edges 101 of the pleated section of the web. Adjustment may include changing both the extent to which the L-shaped rod 99 projects out from the clamp 97 and the angle of the L-shaped rod, as well as the axial location of the L-shaped rod along the mounting bar 41.

The retainer skis 71 are mounted on the mounting bar 73 in the same manner as the skis 45 of the forming section 17 of the pleating apparatus 1. These skis 71 are aligned with the skis 45 of the set 43 on the mounting bar 39. Alignment can be accomplished by turning the knob 79 to move the slide 75 carrying the mounting bar 73. The retainer skis 71 are received in the pleats PL to hold their shape before they reach the press 21. As stated previously, it is envisioned that the retainer 19 may be omitted.

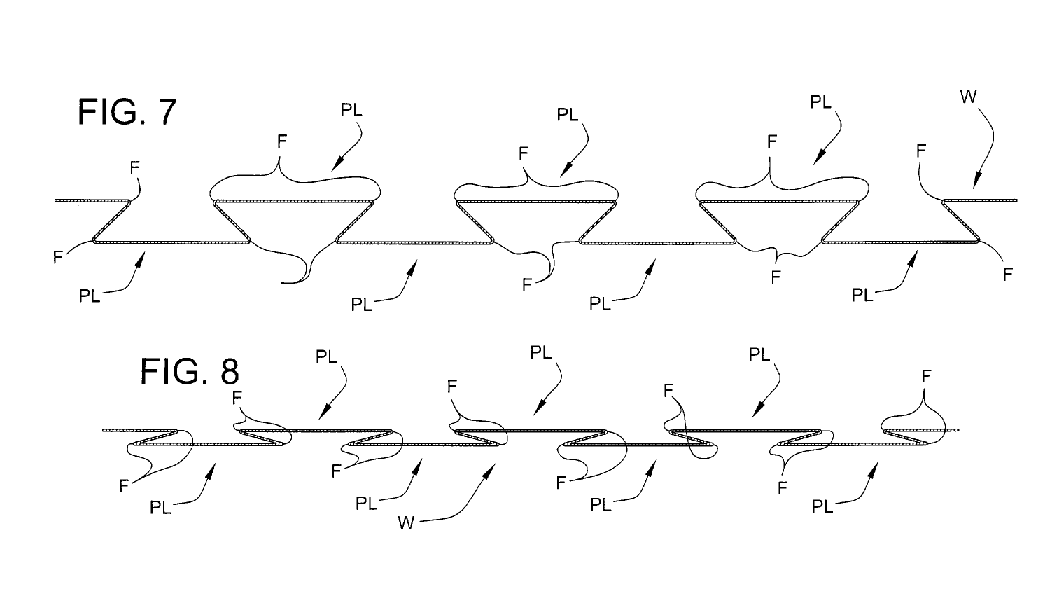

After the web W is threaded through the apparatus 1 and the ski sets 43, 47, material guides 95 and retainer skis 71 are positioned, the web is driven to run lengthwise through the pleating apparatus over the web straightener 11. The web straightener automatically detects the lateral position of the web W relative to a centerline of the path to be followed by the web and to make any necessary corrections in lateral position of the web. The web W entering the forming section 17 is formed by engagement with the interleaved ski sets 43, 47 into a generally sinusoidal shape with a series of folds F corresponding to the longitudinal edges of the runners 49. The material guides 95 engage the web W just to the inside and just to the outside of the inner and outer skis 45 of the set 43 to fold the web around those skis making certain a fold F is formed by the outer longitudinal edges 101 of the runners 49. The formed pleats PL (shown in FIG. 7) are received onto the retainer skis 71 as they pass downward from the forming section 17 to retain their shape.

Upon passage into the press 21, the web W is firmly pressed against itself along the folds F to permanently form the pleats PL into the material of the web. The pressed pleats PL are illustrated in FIG. 8. The pleats PL may be bonded to the web W either before or after entering the press 21. In the illustrated embodiment, a suitable bonder such as an ultrasonic bonder 115 (shown schematically) is disposed just downstream from the press 21. The bonder 115 can be used, for example, to temporarily or permanently attach the material of the pleat PL to the web W between the folds F on each side of the pleat. In one instance a piece of material is formed with a single central pleat, and the pleat is attached to the web W only at intervals along the machine direction MD. Bonding in this manner allows the unbonded portion of the pleat between bonds to unfold in use for desired extension of the pleated material. For example in a diaper, material having such a partially bonded pleat could be used as an inner liner. The unbonded portion of the pleat would allow a middle portion of pleated material to unfold for expanding to receive a bowel movement in a diaper.

However, until the bowel movement is received the bonded portions on each end of the pleated material retain the shape of the pleat and allow the pleated material to be comfortably form fitting. The pleated web W passes from the bonder 115 to a collection device or to another piece of processing machinery (not shown). It will be appreciated that in addition to the initial position of the skis 45, material guides 95 and retainer skis 71, adjustments can be made to these while the apparatus 1 operates, i.e., while the web W moves over these components. Adjustment of the press 21 can also be made while in operation.

It will be appreciated that details of the foregoing embodiment, given for purposes of illustration, are not to be construed as limiting the scope of this invention. Although only one or a few exemplary embodiments of this invention have been described in detail above, those skilled in the art will readily appreciate that many modifications are possible in the exemplary embodiments without materially departing from the novel teachings and advantages of this invention. For example, features described in relation to one embodiment may be incorporated into any other embodiment of the invention. Accordingly, all such modifications are intended to be included within the scope of this invention, which is defined in the following claims and all equivalents thereto. Further, it is recognized that many embodiments may be conceived that do not achieve all of the advantages of some embodiments, yet the absence of a particular advantage shall not be construed to necessarily mean that such an embodiment is outside the scope of the present invention.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. Apparatus for forming folds in a foldable material in a continuous operation, the apparatus comprising a frame adapted for receiving a moving web of the foldable material through the apparatus along a path, and a plurality of skis mounted on the frame and adapted to engage the web of foldable material for use in forming folds in the engaged web as the web of foldable material moves through the apparatus along the path, the skis being mounted for independent adjustment within the apparatus.

2. Apparatus as set forth in claim 1 wherein the skis are mounted for pivoting adjustment about an axis generally transverse to the portion of the path extending through the skis.

3. Apparatus as set forth in claim 2 wherein each of the skis is mounted for adjustment independently of the other skis.

4. Apparatus as set forth in claim 3 wherein each ski comprises a runner and mounting structure including a clamp for releasably and adjustably clamping the ski onto the frame in a selected orientation.

5. Apparatus as set forth in claim 4 wherein the frame includes a bar mounted on and extending from the frame, the bar being adapted for receiving the clamps to mount at least some of the skis thereon.

6. Apparatus as set forth in claim 5 wherein the mounting structure of each ski further comprises a mounting plate extending from the runner, the clamp being attached to the mounting plate.

7. Apparatus as set forth in claim 1 wherein the skis are arranged in generally opposed sets adapted to be interleaved for engaging the web of foldable material to form at least some of the folds and produce pleats.

8. Apparatus as set forth in claim 7 wherein each of the opposed sets of skis is mounted on the frame for movement as a set relative to the frame independently of the other set.

9. Apparatus as set forth in claim 1 further comprising a material guide for engaging the web of foldable material to form the material in cooperation with one of the skis to produce one of the folds.

10. Apparatus as set forth in claim 9 further comprising another material guide for engaging the web of foldable material to form the material in cooperation with another one of the skis to produce another one of the folds.

11. Apparatus as set forth in claim 10 wherein the material guides are adjustably mounted on the frame.

12. Apparatus as set forth in claim 11 wherein the material guides are mounted for both pivoting and translational adjustment.

13. Apparatus as set forth in claim 12 wherein each material guide comprises a rod having a curved portion generally at a distal end thereof, the curved portion being disposed along the path for smooth engagement with the web of foldable material.

14. Apparatus as set forth in claim 1 further comprising a web straightener located along the path of the web of foldable material upstream from the skis for automatically centering the web of foldable material along a centerline of the path.

15. Apparatus as set forth in claim 1 further comprising a retainer ski located along the path adjacent to and downstream from the opposed sets of skis, the retainer ski being adapted to retain folds formed in the foldable material by the skis.

16. Apparatus as set forth in claim 1 further comprising a press located along the path downstream from the skis for pressing the folds into the foldable material.

17. Apparatus as set forth in claim 1 further comprising a bonder for bonding the folded web of foldable material to itself to retain the folds in the foldable material.

18. Apparatus for forming folds in a foldable material in a continuous operation, the apparatus comprising a frame adapted for receiving a moving web of the foldable material through the apparatus along a path, and a plurality of skis mounted on the frame and adapted to engage the web of foldable material for use in forming folds in the engaged web as the web of foldable material moves through the apparatus along the path, and a material guide for engaging the web of foldable material to form the material in cooperation with at least one of the skis to produce at least one of the folds.

19. Apparatus as set forth in claim 18 wherein the material guide is adjustably mounted on the frame.

20. Apparatus as set forth in claim 19 wherein the material guide is mounted for both pivoting and translational adjustment.

21. Apparatus as set forth in claim 20 wherein the material guide comprises a rod having a curved portion generally at a distal end thereof, the curved portion being disposed along the path for smooth engagement with the web of foldable material.

22. Apparatus as set forth in claim 18 further comprising another material guide for engaging the web of foldable material to form the material in cooperation with another one of the skis to produce another one of the folds.

23. Apparatus as set forth in claim 22 wherein the skis are arranged in at least one set and the material guides are located on opposite sides of said at least one set of skis.

24. Apparatus as set forth in claim 23 wherein the skis are arranged in two opposing sets adapted to be interleaved for engaging the web to form at least some of the folds, the material guides being disposed for engaging the web on opposite sides of the interleaved ski sets.

25. Apparatus as set forth in claim 24 wherein the skis are mounted for pivoting adjustment about an axis generally transverse to the portion of the path extending through the skis.

26. Apparatus as set forth in claim 25 wherein each of the skis is mounted for adjustment independently of the other skis.

27. Apparatus as set forth in claim 26 wherein each ski comprises a runner and mounting structure including a clamp for releasably and adjustably clamping the ski onto the frame in a selected orientation.

28. Apparatus as set forth in claim 27 further comprising at least two bars mounted on and extending from the frame generally on opposite sides of the path, the bars being adapted for receiving the clamps to mount the skis thereon.

29. Apparatus as set forth in claim 24 wherein each of the opposed sets of skis is mounted on the frame for movement as a set relative to the frame independently of the other set.

30. Apparatus as set forth in claim 24 further comprising a retainer ski set located along the path adjacent to and downstream from the opposed sets of skis, the retainer ski set being adapted to retain folds formed in the foldable material by the opposed sets of skis.

31. Apparatus as set forth in claim 18 further comprising a press located along the path downstream from the skis for pressing the folds into the foldable material.

32. Apparatus as set forth in claim 18 further comprising a web straightener located along the path of the web of foldable material upstream from the skis for automatically centering the web of foldable material along a centerline of the path.

33. Apparatus as set forth in claim 18 further comprising a bonder for bonding the folded web of foldable material to itself to retain the shape of the folds.

34. Apparatus for forming folds in a foldable material in a continuous operation, the apparatus comprising a frame adapted for receiving a moving web of the foldable material through the apparatus along a path, and a plurality of skis mounted on the frame and adapted to engage the web of foldable material for use in forming folds in the engaged web as the web of foldable material moves through the apparatus along the path, and a web straightener mounted on the frame upstream along the path of the web from the skis for automatically correcting the position of the web laterally of its path.
